(19) United States
(12) Patent Application Publication
(10) Pub. No.: US 2021/0224909 A1
(43) Pub. Date: Jul. 22, 2021

(54) DETERMINING AND EXPRESSING DATA RELIABILITY

(71) Applicant: LEDGEX SYSTEMS, LLC., Waltham, MA (US)

(72) Inventors: Edward P. Meissner, Keswick, VA (US); Christopher M. McCoy, Framingham, MA (US); Nicole A. Eberhardt, Myrtle Beach, SC (US); EliJacob Weinstock-Herman, Cary, NC (US); Lee F. McKinnon, Boxborough, MA (US)

(21) Appl. No.: 16/746,337

(22) Filed: Jan. 17, 2020

(51) Int. Cl. G06Q 40/06; G06F 16/23; G06F 16/22

(52) U.S. Cl. CPC G06Q 40/06; G06F 16/2282; G06F 16/2365

(57) ABSTRACT

Example processes may include the following operations. Confidence scores may be obtained for different components used to determine an estimate. The confidence scores may be weighted to produce weighted confidence scores. A confidence index may be produced for the estimate based, at least in part, on a combination of the weighted confidence scores. The confidence index may correspond to a reliability of the estimate. Data may be generated that is used to render a graphical user interface (GUI) on a display screen of a computing system. The GUI may display the estimate and the confidence index for the estimate, and the GUI may highlight the estimate graphically. Computer-generated graphics that highlight the estimate on the GUI may be based on the confidence index. The data may be output to render the GUI on the display screen of the computing system.

### TECHNICAL FIELD

This specification relates generally to determining the reliability of data and to expressing the reliability of that data graphically.

### BACKGROUND

In the context of data, reliability may be a measure of the extent to which the data is accurate or can be trusted. A report, for example, may contain multiple data elements having varying degrees of reliability.

### SUMMARY

Example processes may include the following operations. Confidence scores may be obtained for different components used to determine an estimate. A confidence score for a component may be based, at least in part, on a reliability of the component over a specified period of time. The confidence scores may be weighted to produce weighted confidence scores. Each of the confidence scores may be weighted based on a perceived importance of each of the different components to the estimate. A confidence index may be produced for the estimate based, at least in part, on a combination of the weighted confidence scores. The confidence index may correspond to a reliability of the estimate. Data may be generated that is used to render a graphical user interface (GUI) on a display screen of a computing system. The GUI may display the estimate and the confidence index for the estimate, and the GUI may highlight the estimate graphically. Computer-generated graphics that highlight the estimate on the GUI may be based on the confidence index. The data may be output to render the GUI on the display screen of the computing system. The example processes may include one or more of the following operations, either alone or in combination.

The example processes may include combining the weighted confidence scores by adding the weighted confidence scores together. A confidence score for at least one component may be generated programmatically based on historical data for the at least one component. The confidence score for at least one component may be generated without user intervention.

The different components may include different types of components. The different types of components may include a quality component, a class component, a source component, an aging component, and a completeness component. The quality component may be based on an origin of data upon which the estimate is based. The class component may be based on an identity of an entity that the estimate is for. The source component may be based on an identity of a source providing information upon which the estimate is based. The completeness component may indicate whether additional information is required or not required for the estimate. The different components may also include a component that is based on an age of the entity that the estimate is for. The age of the entity may correspond to or be based on a date that the entity was last evaluated.

The computer-generated graphics may include colors that change based on the confidence index. The estimate may be highlighted using a color that is based on the confidence index. Information associated with the estimate, such as trailing values, may be also highlighted using the color or a different color that represents a different confidence index. The information associated with the estimate may include trailing values relating to an entity that the estimate is for. The trailing values may be arranged in tabular format. The estimate and the trailing values may be arranged in a row of a table. The row may be highlighted in the color.

The estimate may be part of a portfolio that includes multiple estimates. The processes may include producing a confidence index for the portfolio based, at least in part, on a combination of the multiple estimates. The GUI may display the confidence index for the portfolio graphically.

The GUI may be configurable to specify a period of time for which the confidence index is generated. The confidence scores may be obtained for the period of time specified in the GUI such that the confidence index corresponds to the period of time. The estimate may be for an investment and the GUI may include a performance report containing the estimate and other information about the investment. A portion of the performance report containing the estimate may contain the computer-generated graphics to highlight the portion in a color that is based on the confidence index. The GUI may include a performance report that contains a beginning market value for the investment and a current market value for the estimate. At least one of the beginning market value for the investment and the current market value for the estimate may be highlighted by the computer-generated graphics in one or more colors that are based on the confidence index. The estimate may relate to performance of a manager of an investment portfolio.

The GUI may be configured to accept a user-defined component and information relating to the user-defined component. Display of the computer-generated graphics may be controllable through the GUI. The GUI may be configured to provide, in response to selecting of an on-screen component, at least one of information about background calculations or information about the different components that are used to produce the confidence index.

Any two or more of the features described in this specification, including in this summary section, may be combined to form implementations not specifically described in this specification.

All or part of the processes, methods, systems, and techniques described herein may be implemented as a computer program product that includes instructions that are stored on one or more non-transitory machine-readable storage media, and that are executable on one or more processing devices. Examples of non-transitory machine-readable storage media include, for example, read-only memory, an optical disk drive, memory disk drive, random access memory, and the like. All or part of the processes, methods, systems, and techniques described herein may be implemented as an apparatus, method, or system that includes one or more processing devices and memory storing instructions that are executable by the one or more processing devices to perform the stated operations.

The details of one or more implementations are set forth in the accompanying drawings and the description below. Other features and advantages will be apparent from the description and drawings, and from the claims.

### DESCRIPTION OF THE DRAWINGS

FIG. 1 shows an example of a graphical user interface (GUI) that may be generated by the example processes described herein.

FIG. 2 shows examples of drop-down menus for assigning highlighting colors and meanings to the highlighting colors.

FIG. 3 is a table showing example components of a confidence index, example values of those components, and example weights for the components.

FIG. 4 is a table showing example entities, confidence indices, and operations for determining the confidence indices.

FIG. 5 is a flowchart containing example operations for generating a GUI that highlights estimates using color based on their reliabilities.

The patent or application file contains at least one drawing executed in color. Copies of this patent or patent application publication with color drawing(s) will be provided by the Office upon request and payment of the necessary fee.

Like reference numerals in different figures indicate like elements.

### DETAILED DESCRIPTION

Described herein are example processes, which may be performed by one or more processing devices, for determining the reliability of data and for expressing that reliability graphically. Reliability may be a measure of the extent to which the data is accurate or can be trusted. An example process may generate a confidence index for an estimate. In this example, the estimate is the data for which reliability is determined and expressed. The confidence index may correspond to—for example, represent or be indicative of—a reliability of the estimate. The reliability of the estimate may be based on components that are used to determine the estimate and the historical accuracy of those components over one or more specified periods of time. For example, in an investment context, an estimate of an asset's market value may be determined using various components of information. The reliability of one or more of those components may factor into the reliability of the estimate. For example, capitalization (“cap”) statements are considered highly reliable sources of information. Accordingly, an estimate of current market value that is based, at least in part, on a cap statement of an investment may be considered reliable.

The example processes generate a graphical user interface (GUI) to express the reliability of the data graphically. For example, the estimate may be represented numerically. In an example, the estimate may be a value of an entity that the estimate is for or a percentage above or below an expected value. In the preceding example, the estimate may be a current market value of an investment asset, such as a mutual fund. In this example, the entity is the investment asset. The confidence index, which corresponds to a reliability of the estimate as noted above, may be represented graphically. For example, the confidence index may be represented numerically or using a bar indicator. In an example, the length of a bar indicator may correspond to a magnitude of the confidence index, with a longer bar representing a greater magnitude and a shorter bar representing a lesser magnitude. The confidence index may also be used to highlight the estimate using computer graphics that enable a user quickly to discern the reliability of the estimate. For example, the computer graphics may include color to highlight the estimate.

The color used for highlighting may be based on the confidence index; for example, the color may vary or change based on the reliability of the estimate. In an example, if the estimate is deemed highly reliable, then the estimate may be highlighted in green; if the estimate is deemed moderately reliable, then the estimate may be highlighted in yellow; and if the estimate is deemed likely unreliable, then the estimate may be highlighted in red. There are no specific criteria for specifying what constitutes highly reliable, moderately reliable, or likely unreliable. Instead, those criteria may be configured by a user through the GUI or system. For example, if there is believed to be an 85% chance or greater that an estimate is reliable, the estimate may be highlighted in green; if there is believed to be a 50% to 84% chance that an estimate is reliable, the estimate may be highlighted in yellow; and if there is believed to be less than a 50% chance that an estimate is reliable, the estimate may be highlighted in red. Other color schemes may be used. For example, blue may represent highly reliable; orange may represent moderately reliable; and yellow may represent likely unreliable. In other examples, there may be more than three colors used and/or the colors may represent attributes other than highly reliable, moderately reliable, or likely unreliable. The number of colors, the types of colors, and the meaning of the colors may be set by a user in the GUI or system.

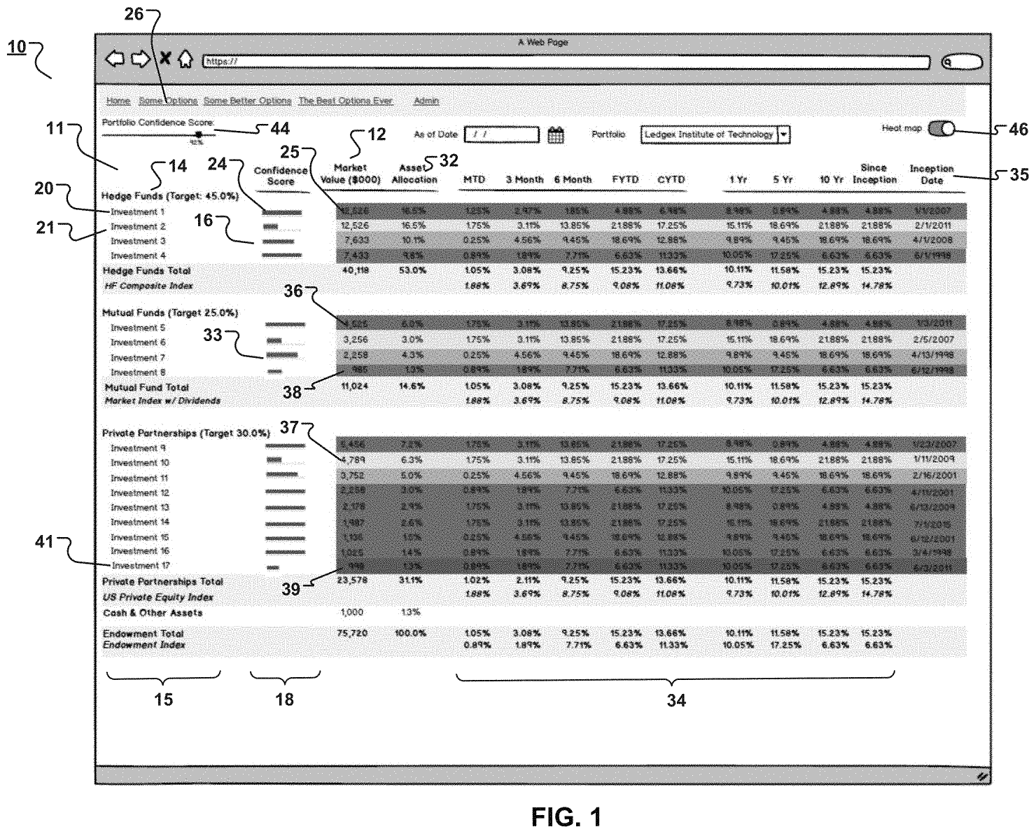

FIG. 1 shows an example GUI 10 that may be generated using the processes described herein. GUI 10 includes an example performance report 11 for an investment portfolio. The performance report includes estimates of current market values 12 for investment vehicles 14 included in the performance report. It is noted, however, that while the processes described herein are explained primarily in a financial context, the processes are not limited to use in a financial context. Rather, the processes and concepts described herein may be used in any appropriate system that determines and expresses the reliability of any appropriate type of data. As shown in FIG. 1, a portion of GUI 10 includes performance report 11 for the investment portfolio. The investment portfolio includes the investment vehicles listed in column 15. In this example, the investment vehicles are categorized by type, including hedge funds, mutual funds, private partnerships, and cash & other assets. Other types of investment vehicles or other categorizations may be used.

Performance report 11 also includes a graphical representation 16 of the confidence index—which also may be called a “confidence score” —for each investment. These are shown in column 18. The confidence indices are represented graphically in this example. As explained previously, in this example, the length of a bar indicator representing the confidence index may correspond to a magnitude of the confidence index, with a longer bar representing a greater magnitude and a shorter bar representing a lesser magnitude. So, for example, the confidence index of “Investment 1” 20 is greater than the confidence index for “Investment 2” 21. In some implementations, the confidence index may be represented numerically. For example, the confidence index of each investment vehicle may be represented on a scale of 1 to 100, with 100 indicating the most confidence and with 1 indicating the least confidence.

In some implementations, the graphical representation of the confidence index may include both the bar indicator and a numerical value representing the confidence index. In implementations, such as that shown in FIG. 1, that include only a bar indicator to represent the confidence index, the bar indicator may be selectable to cause a corresponding numerical value representing the confidence index to be displayed, for example, adjacent to or over overlapping the bar indicator. In implementations that include only a numerical value to represent the confidence index (not shown in FIG. 1), the numerical value may be selectable to cause a corresponding bar indicator representing the confidence index to be displayed, for example, adjacent to or over overlapping the numerical value.

In some implementations, non-numerical computer graphics other than a bar indicator may be used. For example, a pie chart may be used, in which a full circle represents a greatest degree of confidence—that is, a highest confidence index value—and lesser portions of a circle displayed represent lesser degrees of confidence. In another example, the confidence index may be proportional to the size of circle or other geometric object displayed. For example, a larger object may correspond to a greater confidence index whereas as smaller object may correspond to a smaller confidence index. In another example, more than one graphical object may represent the magnitude of the confidence score. For example, multiple circles or other geometric objects may represent the magnitude of the confidence index. In an example, ten small circles arranged linearly may represent the highest confidence index, whereas one small circle may represent the lowest confidence index. Generally, any appropriate computer graphics may be used.

In some implementations, GUI 10 is configured to provide, in response to selection of an on-screen component, information about background calculations or information about different components that are used to produce the estimate and the confidence index. For example, performance report 11 may be, or be part of, a Web page. The computer graphics representing the confidence index, such as bar indicator 24, may include an embedded hyperlink, such as HyperText Transfer Protocol (HTTP) link. The embedded hyperlink, upon selection, may direct a user to another Web page or to a different part of the Web page containing the performance report. There, information about different components that are used to produce the estimate and confidence index may be found. In this regard, as described in more detail herein, the confidence index is based on weighted confidence scores of different components used to determine the estimate. In the example of FIG. 1, the estimate is the market value, such as market value 25, of an investment vehicle. In this example, information about how the estimate is determined may be displayed on the other page or different part of the same page. The information may include the components that went into the estimate, the age of each component, and the mathematical calculations used to obtain the estimate. In some implementations, this information may be displayed in a pop-up window. In general, any appropriate information may be displayed in any appropriate manner.

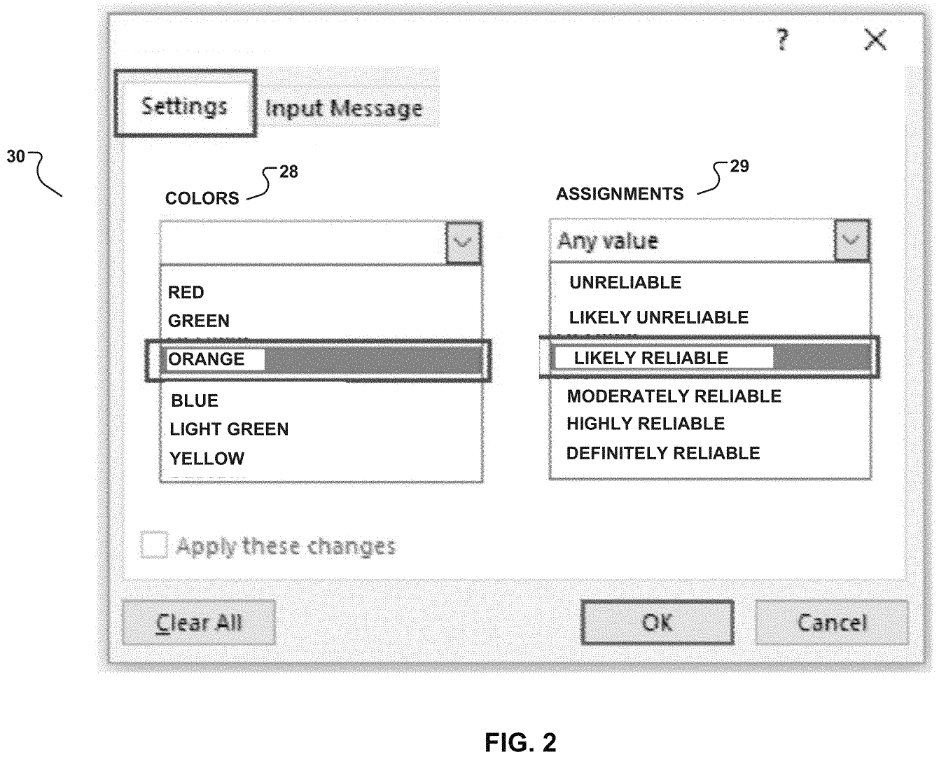

In the example of FIG. 1, GUI 10 displays the estimate and a confidence index for the estimate. The GUI may also highlight the estimate graphically. Computer-generated graphics that highlight the estimate on the GUI may be based on the confidence index. The computer-generated graphics may include colors that change based on the confidence index. In other words, the color used to highlight an estimate may vary based on the reliability of the estimate. In the example of FIG. 1, five colors are used to represent different degrees of reliability. In this example, the colors are green, light green, yellow, orange and red; however, as noted above, different colors and numbers of colors may be used to represent degrees of reliability. In the investment context for example, some may wish not to use green or red because of well-understood other meanings for those colors. Accordingly, the GUI may be configured so that users can select which colors to use, how many colors to use, and the meanings of each of those colors. For example, a menu item, such as “Some Options” 26 may be selected to allow a user to assign colors and their meanings. For example, referring to FIG. 2, a user may be provided via drop-down menus, a list of colors 28 and assignments 29 for their meanings on a GUI 30.

Referring back to the example of FIG. 1, in this case green represents the greatest degree of reliability; light green represents a lesser degree of reliability than green but a greater degree of reliability than yellow; yellow represents a lesser degree of reliability than light green but a greater degree of reliability than orange;

orange represents a lesser degree or reliability than yellow but a greater degree of reliability than red; and red represents the lowest degree of reliability. In this example, the estimate is highlighted in a color that is based on its confidence index, which allows a user readily to discern a level of confidence to place in the estimate. This reduces the need to expend computer processing resources and computer network resources to identify the reliability of the estimate and to determine how the estimate was obtained. As such, the technical solution described herein is rooted in computer technology in order to address a problem specifically arising in the realm of computing. Moreover, since the technical solution described herein incudes generating a GUI and representing content on that GUI using computer graphics, the technical solution cannot be characterized as an abstract mathematical concept, a method of organizing human activity, or a mental process.

In some implementations, the information associated with the estimate includes trailing values relating to an entity that the estimate is for—the investment vehicle, in this example. The trailing values may be arranged in tabular format as shown in FIG. 1. For example, the estimate and the trailing values may be arranged in a row of a table. All or part of the row may be highlighted. In this regard, information associated with the estimate may be highlighted using the same color as the estimate or using a different color than the estimate. In the example of FIG. 1, information associated with the estimate includes “Asset Allocation” 32, which is the percentage of the entire portfolio that the associated investment vehicle represents. This information also includes performance information 34. In this example, the performance information is represented by percentage increases or decreases in value of an asset from a predefined baseline for a given time period. The time periods in this example are month-to-date (“MTD”), “3 Months”, “6 Months”, fiscal year-to-date (“FYTD”), calendar year-to-date (“CYTD”), one year (“1 Yr”), five years (“5 Yr”), and “Since Inception”. The information also includes the “Inception Date” 35 of the investment. This performance information is characterized as “trailing” since it may change based on updated information but trails the current market value in time. In some implementations, all or some of this information may be replaced with different information. In some implementations, one or more features may be omitted. In the example of FIG. 1, all information associated with an estimate, such as estimate 36, is highlighted in the same color as the estimate—in this example, green. This is shown also for estimates 37, 38, and 39, which are highlighted in yellow, orange, and red, respectively, as is their associated information. In some implementations, information associated with the estimate may be highlighted using a different color representing a different confidence index. For example, trailing values associated with the estimate may have a greater reliability than the estimate itself, since those trailing values may be based on more reliable data. For example, in the case of investment vehicle 41, which is highlighted in red, the trailing values such as MTD, 3 Months, 6 Months, and so forth, may be based on reliable data and therefore, may have a greater confidence index than the estimate. For example, the trailing values may be highlighted green while the estimate of the current market value associated with those trailing values may be highlighted in red. As shown in FIG. 1, the GUI may also include a confidence index 44 for the entire portfolio that is based, at least in part, on a combination of the multiple estimates. For example, the confidence index for the portfolio may be determined based on a weighted average of confidence indices in column 18 for each investment vehicle. Each weight may correspond to the asset allocation for an investment vehicle. In the example of FIG. 1, confidence index 24 is given a weight of 0.165 since “Investment 1” is 16.5% of the portfolio, whereas confidence index 33 is given a weight of 0.043 since “Investment 7” is 4.3% of the portfolio. The weights are applied to numerical values of the confidence indices. Example processes for determining those numerical values are described herein.

GUI 10 displays graphically the confidence index (or “score”) 44 for the portfolio represented by performance report 11. In this example, the graphical display includes both a numerical confidence score and a bar indicator to show how the confidence score rates graphically on a scale of 1 to 100. In some implementations, the confidence score for the portfolio may also be color-coded according to a selected color scheme as described herein.

In some implementations, display of the computer-generated graphics is controllable through GUI 10. For example, display of the computer-generated graphics may be controllable by interacting with one or more on-screen graphical control elements. In the example of FIG. 1, the color highlighting may be turned-on or turned-off via toggle switch 46. In this example, moving toggle switch to the right as shown causes processes executing to generate GUI 10 to display the highlighting. In this example, moving toggle switch to the left (not shown) causes processes executing to generate GUI 10 not to display the highlighting. In some implementations, a scroll bar may be used to lighten or darken the highlighting in order to make the highlighting more prominent or less prominent. In some implementations, one or more graphical control elements such as a radio button or drop-down list may be used to select which of the highlighting colors may or may not be displayed. For example, a drop-down list may list all colors that are available along with their corresponding meaning. A user may manually select one, a set, or all of the colors to display. For example, a user may only be interested in estimates that are deemed not likely reliable. Accordingly, in this example, the user may select to display only red or other color highlighting to identify unreliable estimates. In some implementations, each confidence index is based on the reliability of different components used to produce the estimate. For example, the confidence index for “Investment 1” 20 is based on the reliability of different components used to produce its estimated market value 25. Each such confidence score for a component is based, at least in part, on a reliability of the component over a specified period of time. For example, confidence scores for different types of components may be stale if based on old data or overly speculative if based on new data that is uncertain. Accordingly, as described below, the age of the data used to determine each confidence score may affect that data's reliability.

Confidence scores for individual components of the estimate are weighted to produce weighted confidence scores. The confidence scores are weighted based on a perceived importance of each of the different components to the estimate. For example, some components may be deemed more important to a confidence score than other components. Those components that are deemed more important may be weighted more heavily than others of the components.

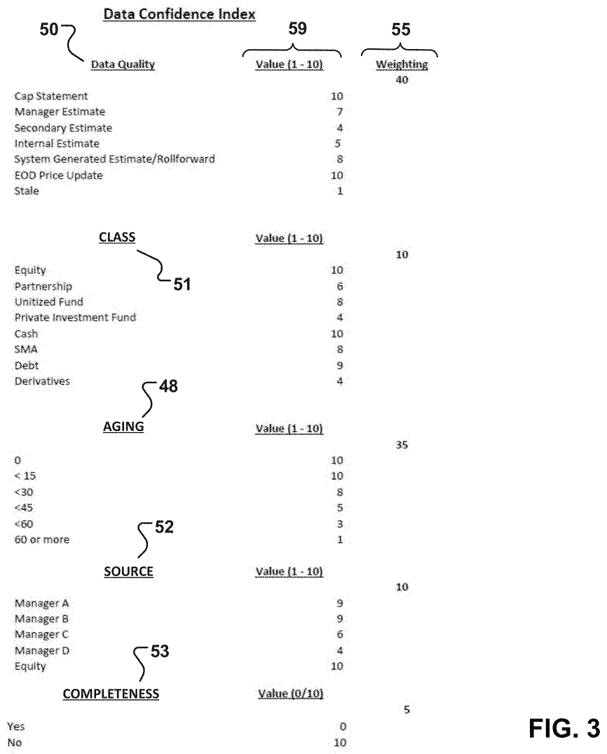

FIG. 3 shows examples of components that may be used to produce the estimates of market value shown in GUI 10 and to produce the confidence scores for the estimates of market value. Notably, in some implementations, different components than those shown in FIG. 3 may be used; one or more components shown in FIG. 3 may be omitted; different values than those shown in FIG. 3 may be assigned; and/or different weights than those shown in FIG. 3 may be applied. Furthermore there may be fewer components than those shown in FIG. 3 or more components than those shown in FIG. 3.

In the example of FIG. 3, the different components include five different types of components. These types of components include a quality component 50, a class component 51, an aging component 48, a source component 52, and a completeness component 53.

Quality component 50, or “Data Quality”, is based on an origin or source of data upon which the estimate is based. In this example, the origin of the data may be one of the following sources: a cap statement, a manager estimate, a secondary estimate, an internal estimate, a system generated estimate or roll-forward, an end-of-day (“EOD”) price update, or predefined stale data. Each of these quality components is deemed to have a confidence score which, in this example, is a value between 1 and 10 inclusive, with 10 being the greatest confidence and 1 being the least confidence. In this context, confidence may correspond to—for example, represent or be indicative of—a reliability of the component. The confidence scores may be predefined based on historical accuracy of information from the various quality components. The confidence scores may be determined and revised dynamically and in real-time by computer code executed to produce GUI 10. Real-time may include, but is not limited to, actions that occur on a continuous basis or track each other in time, taking into account delays associated with processing, data transmission, hardware, and the like. In some cases, determinations and revisions of the confidence scores may be implemented programmatically with or without user intervention. For example, the computer code may continually, periodically, intermittently, or sporadically determine the accuracy of information from the various quality components and update their confidence scores accordingly. In this example, the cap statement and EOD quality components are deemed the most reliable. Accordingly, they are assigned the highest confidence scores, that is “10”. Other quality components are assigned confidence scores that are commensurate with their reliabilities.

Class component 51, or “Class”, is based on the identity of an entity that the estimate is for, which may be an asset or a person. In this example, the entity may be one of the following types of investments: an equity, a partnership, a unitized fund, a private investment fund, cash, a separately managed account (“SMA”), debt, or derivatives. Each of these class components is deemed to have a confidence score which, in this example, is a value between 1 and 10 inclusive, with 10 being the greatest confidence and 1 being the least confidence. In this example, confidence may correspond to—for example, represent or be indicative of—a reliability of information about a particular component. The confidence scores may be predefined based on historical accuracy of information about the various class components. The confidence scores may be determined and revised dynamically and in real-time by computer code executed to produce GUI 10. Such determinations and revisions may be made without user intervention. For example, the computer code may continually, periodically, intermittently, or sporadically determine the accuracy of information about the various class components and update their confidence scores accordingly. In this example, the equity and cash class components are deemed the most reliable in terms of specifying the market value of the asset. Accordingly, they are assigned the highest confidence scores, that is “10”. Other class components are assigned confidence scores that are commensurate with their reliabilities.

Aging component 48, or “Aging”, is based on an age of the entity that the estimate is for. In the example of FIG. 3, the ages include 0 (for example, current), less than 15 days old (“<15”), less than 30 days old (“<30”), less than 45 days old (“<45”), less than 60 days old (“<60”), or more than 60 days old (“60 or more”). However, these are examples only and any appropriate aging values and corresponding scores may be used. Each of these aging components is deemed to have a confidence score which, in this example, is a value between 1 and 10 inclusive, with 10 being the greatest confidence and 1 being the least confidence.

The age of the entity may correspond to a date that the entity was last evaluated. In the case of an investment vehicle, such as an equity or a partnership, the age of the investment vehicle is based on the date that the investment vehicle was last subjected to valuation. For example, the age may include the difference between a reporting valuation date and an economic valuation date. In some examples, aging affects the confidence index for the entity. For example, age may weight the overall confidence index more or less heavily based on a class of the entity. For example, there may be more confidence in information about a partnership having a last valuation that is 1 to 15 days old than in information about at partnership that is 16 to 30 days old. In addition, age may affect different types of class components differently. For example, the confidence in the value of an equity having a valuation that is more than 3 days old may be less than the confidence in a private investment having a valuation that is more than 30 days old because equities are valued more frequently than private investments and their valuation information is typically more readily available. The confidence scores and corresponding weights shown in FIG. 3 for aging and class may be generated to take these effects into account. The aging confidence scores may be determined and revised dynamically and in real-time by computer code executed to produce GUI 10. Such determinations and revisions may be implemented programmatically with or without user intervention. For example, the computer code may continually, periodically, intermittently, or sporadically determine or update the aging confidence scores.

Source component 52, or “Manager Confidence”, is based on an identity of a source providing information upon which the estimate is based. In this example, the source may be one of the following: an equity or one of four investment managers labeled A, B, C, and D. Each of these source components is deemed to have a confidence score which, in this example, is a value between 1 and 10 inclusive, with 10 being the greatest confidence and 1 being the least confidence. In this example, confidence may correspond to—for example, represent or be indicative of—a reliability of information from a particular component, for example, how often information from a particular source is accurate. The confidence scores may be predefined based on historical accuracy of information from the various source components. The confidence scores may be determined and revised dynamically and in real-time by computer code executed to produce GUI 10. Such determinations and revisions may be implemented programmatically with or without user intervention. For example, the computer code may continually, periodically, intermittently, or sporadically determine the accuracy of information from the various source components and update their confidence scores accordingly. For example, if a manager is consistently inaccurate, the confidence score associated with that manager may be reduced relative to those of other managers. In this example, the equity component is deemed the most reliable. Accordingly, that component is assigned the highest confidence scores, that is “10”. Other class components, such as Managers A and B, are assigned confidence scores that are commensurate with their reliabilities.

Completeness component 53, or “Follow up”, indicates whether additional information is required or not required to finalize the estimate. In this example, the completeness component may indicate that additional follow-up information is required to complete the estimate (“Yes”) or that no additional follow-up information is required to complete the estimate (“No”). Each of these completeness components is deemed to have a confidence score which, in this example, is a value of 0 or 10. If additional information is required, the estimate is deemed less reliable and is assigned a value of 0. If additional information is not required, the estimate is deemed more reliable and is assigned a value of 10.

Each of the preceding components is assigned a weight, examples of which are shown in column 55 of FIG. 3. Confidence scores 59 from the components are weighted based on a perceived importance of each of the different components to the estimate. The weights may be determined based on empirical observations and/or an analysis of data relating to the estimate in question. The weights may be set based on user input or generated automatically. In the example of FIG. 3, it has been determined that data quality is the most important factor in determining market value (the estimate, in this example). Accordingly, the confidence score of the quality component is weighted more heavily that confidence scores from the other components. The other components are weighted less heavily since it has been determined that the class component (weighted 10), the aging component (weighted 35), the source component (weighted 10), and the completeness component (weighted 5) are less important than the quality component. Different weights may be applied as appropriate and/or the weights may change over time based on historical analysis of the data. In some cases, determinations and revisions of the weights may be implemented programmatically with or without user intervention. For example, computer code may continually, periodically, intermittently, or sporadically determine the accuracy of the weights based on a historical analysis of data, user input, or other factors, and update the weights accordingly.

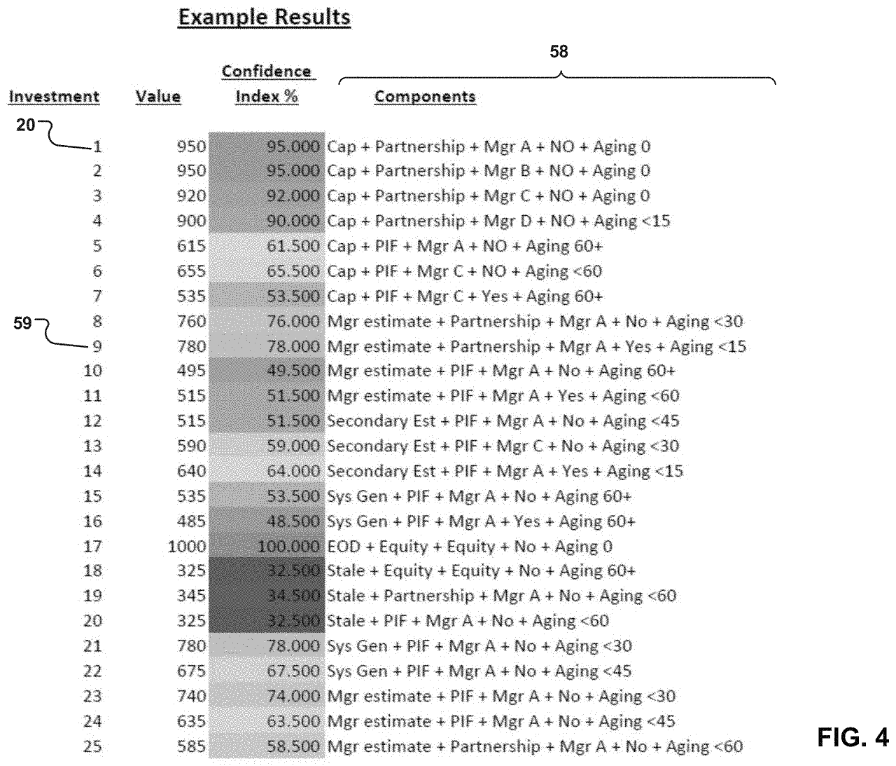

In this example, a confidence index for an estimate such as the market value of Investment 1 is based, at least in part, on a combination of the weighted confidence scores from components used to determine the estimate. For example, referring also to FIGS. 1 and 4, for Investment 120, the quality component is “cap statement”, the class component is “partnership”, the source component is “Manager A” (Mgr A), the completeness component is “No”, and the aging component is “0”. The sum of the various components included in Investment 1 is represented as (Cap +Partnership+Mgr A+No+Aging0). The confidence index for Investment 1 is therefore determined as follows.

quality component: cap statement—confidence score of 10

weight of 40 multiplied by confidence score of 10 equals 400

class component: partnership—confidence score of 6

weight of 10 multiplied by confidence score of 6 equals 60

aging component: “0” —confidence score of 10

weight of 35 multiplied by confidence score of 10 equals 350

source component: manager A—confidence score of 9

weight of 10 multiplied by confidence score of 9 equals 90

completeness component: No—confidence score of 10

weight of 5 multiplied by confidence score of 10 equals 50

sum of weighted confidence scores: 400+60+350+90+50 equals 950

divide 950 by 10 to produce a 95% confidence index for Investment 1

These calculations may be performed based on stored data and/or data received in real-time for a component by processes executing to generate GUI 10. After the confidence index is determined, the confidence index is classified by color. In this example a 95% confidence index is deemed to be highly reliable and therefore it is associated with green highlighting that may be displayed on GUI 10.

The confidence indices for example investments 1 to 25 of FIG. 4 are determined using the components shown in adjacent column 58 of FIG. 4. For example, for Investment 9 59, the quality component is “manager estimate” (“Mgr Estimate”), the class component is “partnership”, the source component is “Manager A” (Mgr A), the completeness component is “Yes”, and the aging component is “<15”. The sum of the various components included in Investment 9 is represented as (Mrg Estimate+Partnership+Mgr A+Yes+Aging<15). Calculations for determining the confidence index of 78% for Investment 9 are similar to those provided for Investment 1 above. In this example a 78% confidence index is associated with light green highlighting that may be displayed on GUI 10.

Referring to FIG. 1, as explained above, GUI 10 is configured to provide, in response to selection of an on-screen component, information about background calculations and/or information about the different components that are used to produce the confidence index. In the example of Investment 1, the information about the different components that are used to produce the confidence index may include the identities of each component, their confidence scores, and/or their weights. In the example of Investment 1, the background calculations may include the preceding calculations that determine the confidence index for Investment 1. Explanations associated with those calculations may also be provided.

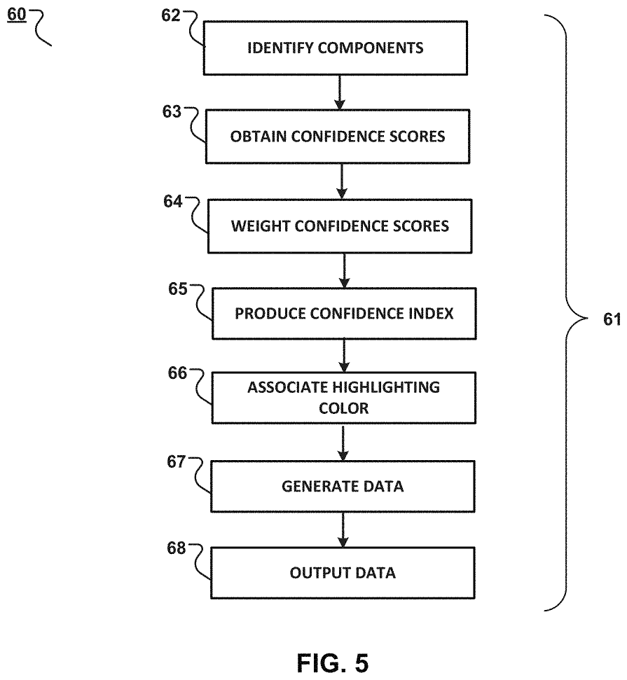

FIG. 5 shows operations included in an example process 60 for determining the reliability of data and for expressing the reliability of that data graphically. Operations 61 included in process 60 may be implemented as machine-readable instructions that are executable by one or more processing devices, such as a computing system. For example, operations 61 included in process 60 may be implemented wholly or partly in a cloud computing environment.

Process 60 includes identifying (62) components that are used to produce an estimate. The components may be based on available information for the estimate. For example, information available to produce an estimated market value for an investment may include a quality component, a class component, an aging component, a source component, and a completeness component. In some cases, there may be more than one component per category available to produce the estimate. For example, there may be both a cap statement and a manager estimate available for a particular investment. In some cases, the processes described herein may automatically select the quality component that is most reliable based on the confidence scores of the available quality components. In this example, that is the cap statement.

Process 60 includes obtaining (63) confidence scores for the components used to determine the estimate. As noted, a confidence score for a component is based, at least in part, on a reliability of the component over a specified period of time. The confidence scores, examples of which are shown in FIG. 3 (“values 59”), may be stored in computer memory and retrieved therefrom. The confidence scores may be determined through calculations based on historical data. The confidence scores may be received through input on a user interface. In general, any appropriate operations may be performed to obtain the confidence scores. Process 60 includes weighting (64) the confidence scores to produce weighted confidence scores. As noted, each of the confidence scores may be weighted based on a perceived importance of each of the different components to the estimate. For example, a component is selected, a confidence score for the component is obtained, and a weight is applied to the confidence score. In an example, a weight of 40 is multiplied by the quality component, a weight of 10 is multiplied by the class component, a weight of 35 is multiplied by the aging component, a weight of 10 multiplied by to the source component, and a weight of 5 is multiplied by the completeness component.

Process 60 includes producing (65) a confidence index for the estimate based, at least in part, on a combination of the weighted confidence scores. The confidence index corresponds to a reliability of the estimate, for example. Example calculations for producing a confidence index for Investment 1 are provided herein. Other calculations for different entities are similar. A highlighting color is associated (66) with the estimate. The color is based on the reliability of the estimate as indicated by the confidence index, as described herein. Data representing the highlighting color may be stored in a database in association with the estimate and may be used by process 60 to generate the highlighting on a GUI. Process 60 includes generating (67) data that is used to render the GUI on a display screen of a computing system. The GUI displays the estimate and the confidence index for the estimate. The GUI highlights the estimate graphically, for example using a highlighting color that corresponds to the confidence index in order to identify the reliability of the estimate. As explained previously, the highlighting color may or may not extend to information associated with the estimate.

Process 60 includes outputting (68) the generated data to render the GUI on the display screen of the computing system. For example, a graphics processing unit (GPU) may render the GUI on a display device using the data. A user may interact with and configure the GUI as desired as described herein. These configurations may be stored in a user profile or the like. In some implementations, process 60 may run continuously and update the performance report dynamically and in real-time as confidence indices and/or confidence scores are updated. For example, confidence indices may be updated in real-time and the display of the GUI may be refreshed in real-time and automatically to include those updates. The example processes described herein are not limited to producing a GUI such as those shown in FIG. 1. For example, a GUI may include a performance report that contains a beginning market value for an investment and a current market value for the estimate. At least one of the beginning market value for the investment or the current market value for the estimate may be highlighted by the computer-generated graphics in one or more colors that are based on a confidence index of the estimate. Other information such as that described herein may also be included.

In some implementations, the processes described herein may be used to produce an estimate that relates to performance of a manager of an investment portfolio. For example, the performance of a manager may be estimated using weighted confidence scores of various components that are used to determine the estimate. A confidence index for the manager may then be generated and displayed graphically on a GUI using appropriate color highlighting for the confidence index.

In an example implementation, manager confidence is a parameter that is taken into account in determining the confidence index. The parameter may be defined as a measurement of the perceived level of confidence in valuation data provided by a manager. In an example, a confidence value is assigned to the manager. An initial manager confidence value may be user-defined or system-defined and may be updated manually or programmatically. The manager confidence value may be defaulted to a value of 10 on a scale of 1 to 10 for a new manager created within the system. A client can then adjust the value in order to affect the rating of the manager. The manager confidence value may be affected by the reliability of data provided about the manager, the source of the data provided about the manager, typical timing of data provided by the manager relating to the portfolio that the manager is handling, and the complexity of the portfolio that the manager is handling. With regard to the reliability of data, that information may be based on subjective determinations by users or by system-determined assessments of data provided by the manger. With regard to the source of data, that information may be based on subjective determinations by users or by system-determined assessments of data provided by the manger. For example, data provided by the manager may be deemed less reliable if there is not independent third party validation of pricing and calculation methodologies used by the manager. For example, data provided by a manager may be deemed more reliable if there is independent third party validation of pricing and calculation methodologies used by the manager. With regard to the timing of the data provided by the manager, that information may be based on whether the manager is or is not typically within the boundaries of standard reporting timeframes for reporting information about the portfolio that the manager is handling. In some implementations, this information may be input by a user or determined programmatically by the system. With regard to the complexity of the underlying portfolio that the manager is handling, that information may be based on whether the portfolio is a long/short equity portfolio or a convertible arbitrage portfolio. In some implementations, the complexity of the portfolio may be manually factored into a single rating for each manager. In some implementations, the complexity of the portfolio may be broken-out a separate parameter that is factored into the overall manager confidence value.

Computing systems that may be used to implement all or part of the example processes described herein may include various forms of digital computers. Examples of digital computers include, but are not limited to, laptops, desktops, workstations, personal digital assistants, servers, blade servers, mainframes, smart televisions and other appropriate computers. Mobile devices are examples of computing devices that may be used to implement all or part of the processes described herein. Mobile devices include, but are not limited to, tablet computing devices, personal digital assistants, cellular telephones, smartphones, and other portable computing devices. The computing devices described herein, their connections and relationships, and their functions, are meant to be examples only, and are not meant to limit implementations of the technology. All or part of the processes described herein and their various modifications (referred to as “the processes”) can be implemented, at least in part, via a computer program product, e.g., a computer program tangibly embodied in one or more information carriers, e.g., in one or more non-transitory machine-readable storage media, for execution by, or to control the operation of, data processing apparatus, e.g., a programmable processor, a computer, or multiple computers

A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected by a network.

Actions associated with implementing the processes can be performed by one or more programmable processors executing one or more computer programs to perform the functions of the calibration process. All or part of the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computing system (including a server) include one or more processors for executing instructions and one or more storage area devices for storing instructions and data. Generally, a computing system will also include, or be operatively coupled to receive data from, or transfer data to, or both, one or more machine-readable storage media, such as mass storage devices for storing data, e.g., magnetic, magneto-optical disks, or optical disks. Non-transitory machine-readable storage media suitable for embodying computer program instructions and data include all forms of non-volatile storage area, including by way of example, semiconductor storage area devices, e.g., EPROM, EEPROM, and flash storage area devices; magnetic disks, e.g., internal hard disks or removable disks; magneto-optical disks; and CD-ROM and DVD-ROM disks.

Each computing device, such as a tablet computer, or system of one or more computing devices may include a hard drive for storing data and computer programs, and a processing device (e.g., a microprocessor) and memory (e.g., RAM) for executing computer programs. Each computing device or system may include an image capture device, such as a still camera or video camera. The image capture device may be built-in or simply accessible to the computing device.

Each computing device or system may include a graphics system, including a display screen. A display screen, such as an LCD (Liquid Crystal Display) or a CRT (Cathode Ray Tube) displays, to a user, images that are generated by the graphics system of the computing device. As is well known, display on a computer display (e.g., a monitor) physically transforms the computer display. For example, if the computer display is LCD-based, the orientation of liquid crystals can be changed by the application of biasing voltages in a physical transformation that is visually apparent to the user. As another example, if the computer display is a CRT, the state of a fluorescent screen can be changed by the impact of electrons in a physical transformation that is also visually apparent. Each display screen may be touch-sensitive, allowing a user to enter information onto the display screen via a virtual keyboard. On some computing devices, such as a desktop or smartphone, a physical QWERTY keyboard and scroll wheel may be provided for entering information onto the display screen.

Each computing device or system, and computer programs executed thereon, may also be configured to accept voice commands, and to perform functions in response to such commands. For example, the example processes described herein may be initiated at a client, to the extent possible, via voice commands. The processes described herein may be implemented using cloud computing.

The “cloud” includes, but is not limited to, computing systems that are external to a user or device, and that may offer services to process data, store data, and/or transmit data. For example, the cloud may include, and be implemented using, a network of computers (e.g., servers and/or other types of processing devices), which may be accessible over one or public and/or private networks (e.g., the Internet and/or one or more intranets). Different computers in the cloud may perform different functions or the functions performed by different computers may be duplicated. For example, some computers may use computing resources to run applications or to deliver services, whereas other computers may perform other functions, such as data storage, load balancing, communications, network routing, and so forth. The cloud is typically accessible from any device through connection to a network. Computers or devices in the cloud can store a user's content temporarily or persistently, and can be used to implement the processes.

Elements of different implementations described herein may be combined to form other implementations not specifically set forth above. Elements may be left out of the processes, computer programs, user interfaces, and other features described herein without adversely affecting their operation or the operation of the processes in general. Furthermore, various separate elements may be combined into one or more individual elements to perform the functions described herein.

Other implementations not specifically described herein are also within the scope of the following claims.

What is claimed is:

1. A method performed by one or more processing devices, comprising:
obtaining confidence scores for different components used to determine an estimate, where a confidence score for a component is based, at least in part, on a reliability of the component over a specified period of time;
weighting the confidence scores to produce weighted confidence scores, each of the confidence scores being weighted based on a perceived importance of each of the different components to the estimate;
producing a confidence index for the estimate based, at least in part, on a combination of the weighted confidence scores, the confidence index corresponding to a reliability of the estimate;
generating data that is used to render a graphical user interface (GUI) on a display screen of a computing system, the GUI displaying the estimate and the confidence index for the estimate, and the GUI highlighting the estimate graphically, where computer-generated graphics that highlight the estimate on the GUI are based on the confidence index; and
outputting the data to render the GUI on the display screen of the computing system.

2. The method of claim 1, wherein the different components comprise different types of components, the different types of components comprising a quality component, a class component, a source component, and a completeness component, where the quality component is based on an origin of data upon which the estimate is based, where the class component is based on an identity of an entity that the estimate is for, where the source component is based on an identity of a source providing information upon which the estimate is based, and where the completeness component indicates whether additional information is required or not required for the estimate.

3. The method of claim 2, wherein the different components comprise a component that is based also on an age of the entity that the estimate is for, where the age of the entity corresponds to a date that the entity was last evaluated.

4. The method of claim 1, wherein the computer-generated graphics comprise colors that change based on the confidence index, where the estimate is highlighted using a color that is based on the confidence index, and where information associated with the estimate is also highlighted using the color or a different color that represents a different confidence index.

5. The method of claim 4, wherein the information associated with the estimate comprises trailing values relating to an entity that the estimate is for, the trailing values being arranged in tabular format.

6. The method of claim 5, wherein the estimate and the trailing values are arranged in a row of a table, the row being highlighted in the color.

7. The method of claim 1, wherein the computer-generated graphics comprise colors that change based on the confidence index, where the estimate is highlighted using a color that is based on the confidence index, and where information associated with the estimate is also highlighted using a different color representing a different confidence index.

8. The method of claim 1, wherein the estimate is part of a portfolio comprising multiple estimates; and
wherein the method further comprises producing a confidence index for the portfolio based, at least in part, on a combination of the multiple estimates;
wherein the GUI displays the confidence index for the portfolio graphically.

9. The method of claim 1, wherein a confidence score for at least one component is generated programmatically based on historical data for the at least one component.

10. The method of claim 9, wherein the confidence score for at least one component is generated without user intervention.

11. The method of claim 1, wherein the GUI is configurable to specify a period of time for which the confidence index is generated; and
wherein the confidence scores are obtained for the period of time specified in the GUI such that the confidence index corresponds to the period of time.

12. The method of claim 1, wherein the estimate is for an investment and the GUI includes a performance report containing the estimate and other information about the investment, where a portion of the performance report containing the estimate contains the computer-generated graphics to highlight the portion in a color that is based on the confidence index.

13. The method of claim 1, wherein the estimate is for an investment and the GUI includes a performance report that contains a beginning market value for the investment and a current market value for the estimate, at least one of the beginning market value for the investment and the current market value for the estimate being highlighted by the computer-generated graphics in one or more colors that are based on the confidence index.

14. The method of claim 1, wherein the estimate relates to performance of a manager of an investment portfolio.

15. The method of claim 1, wherein the GUI is configured to accept a user-defined component and information relating to the user-defined component.

16. The method of claim 1, wherein display of the computer-generated graphics is controllable through the GUI.

17. The method of claim 1, further comprising combining the weighted confidence scores by adding the weighted confidence scores together.

18. The method of claim 1, wherein the GUI is configured to provide, in response to selecting of an on-screen component, at least one of information about background calculations or information about the different components that are used to produce the confidence index.

19. One or more non-transitory machine-readable media storing instructions that are executable by one or more processing devices to perform operations comprising:
obtaining confidence scores for different components used to determine an estimate, where a confidence score for a component is based, at least in part, on a reliability of the component over a specified period of time;
weighting the confidence scores to produce weighted confidence scores, each of the confidence scores being weighted based on a perceived importance of each of the different components to the estimate;
producing a confidence index for the estimate based, at least in part, on a combination of the weighted confidence scores, the confidence index corresponding to a reliability of the estimate;
generating data that is used to render a graphical user interface (GUI) on a display screen of a computing system, the GUI displaying the estimate and the confidence index for the estimate, and the GUI highlighting the estimate graphically, where computer-generated graphics that highlight the estimate on the GUI are based on the confidence index; and
outputting the data to render the GUI on the display screen of the computing system.

20. A system comprising:
memory storing instructions that are executable; and
one or more processing devices to execute the instructions to perform operations comprising:
obtaining confidence scores for different components used to determine an estimate, where a confidence score for a component is based, at least in part, on a reliability of the component over a specified period of time;
weighting the confidence scores to produce weighted confidence scores, each of the confidence scores being weighted based on a perceived importance of each of the different components to the estimate;
producing a confidence index for the estimate based, at least in part, on a combination of the weighted confidence scores, the confidence index corresponding to a reliability of the estimate;
generating data that is used to render a graphical user interface (GUI) on a display screen of a computing system, the GUI displaying the estimate and the confidence index for the estimate, and the GUI highlighting the estimate graphically, where computer-generated graphics that highlight the estimate on the GUI are based on the confidence index; and
outputting the data to render the GUI on the display screen of the computing system.
